(19) United States
(12) Patent Application Publication
(10) Pub. No.: US 2022/0295158 A1
(43) Pub. Date: Sep. 15, 2022

(54) SYSTEMS, METHODS, AND DEVICES FOR RECORDING AND/OR STORAGE OF A DIGITAL VIDEO ASSET

(71) Applicant: Comcast Cable Communications, LLC, Philadelphia, PA (US)

(72) Inventors: Christopher Lintz, Denver, CO (US); Spencer Schumann, Castle Rock, CO (US)

(21) Appl. No.: 17/249,756

(22) Filed: Mar. 11, 2021

(51) Int. Cl. H04N 21/845; H04N 21/4147; H04N 21/84

(52) U.S. Cl. CPC H04N 21/8456; H04N 21/4147; H04N 21/84

(57) ABSTRACT

Requests to record a digital video asset on a video stream may be classified in batches. Each request in a batch is associated with the same digital video asset. Each digital video asset may be associated with a plurality of recording services. If a quantity of requests in a first batch satisfies a threshold, the first batch may be sent to a first recording service of the plurality of recording services. If a quantity of requests in a second batch satisfies the threshold, the second batch may be sent to a second recording service of the plurality of recording services.

### BACKGROUND

Digital video has become the one of the most common video distribution channels in recent years. Digital video distribution may assume any of a number of forms, including digital cable, on-demand cable television service, digital video streaming, and digital video recorders (cloud or local). For example, a cloud digital video recorder (DVR) may generate recordings of digital video programs and send the recordings to a storage subsystem. However, the performance of a cloud digital video recorder may be adversely affected if a large quantity of people requests a recording of the same digital video program. Therefore, improvements in digital video recording techniques are needed.

### SUMMARY

Systems, methods, and devices relating to recording and/or storing digital video assets are described herein. A plurality of viewers may request a recording and/or the storage of at least one digital video asset. The requests may be classified in batches based on digital video asset. Each batch may comprise a quantity of requests for the same digital video asset. If a batch comprises a quantity of requests within a range of an optimal quantity of requests, the batch may be sent to a recording service, such as a manifest agent, associated with the digital video asset. At the recording service, an indication of segment data for the requests in the batch may be generated. A plurality of recording services may be associated with a single digital video asset. For example, two different batches comprising requests for the same digital video asset may be sent to different recording services. If a batch does not comprise a quantity of requests within a range of the optimal quantity of requests, an additional request may be classified in the batch.

### BRIEF DESCRIPTION OF DRAWINGS

The accompanying drawings, which are incorporated in and constitute a part of this specification, illustrate embodiments and together with the description, serve to explain the principles of the systems, methods, and devices:

FIG. 1 is a block diagram of an example system.

FIG. 2a is a flow diagram of an example method.

FIG. 2b is a flow diagram of an example method.

FIG. 3 is a flow diagram of an example method.

FIG. 4 is a flow diagram of an example method.

FIG. 5 is a flow diagram of an example method.

FIG. 6 is a block diagram of an example data maintenance system.

FIG. 7 is a block diagram of an example computing system.

Aspects of the disclosure will now be described in detail with reference to the drawings, wherein like reference numbers refer to like elements throughout, unless specified otherwise.

### DETAILED DESCRIPTION

Systems, methods, and devices relating to recording and/or storing digital video assets are described. A recording and/or storage platform (e.g. a cloud DVR platform) may comprise a plurality of services, such as recording services (e.g. manifest agents). Each service may be assigned to a particular video stream, such as a regional NBC stream or a regional A&E stream. The service assigned to a video stream may monitor the metadata associated with digital video assets, such as video programs, on the video stream. For example, the service assigned to a regional NBC stream may monitor the metadata associated with television programs on the regional NBC stream. When a user requests a recording and/or the storage of a digital video asset on a stream, the assigned service may send a request to a segment recorder. The request may comprise the metadata associated with the digital video asset. The segment recorder may receive the request from the service, fetch at least one segment associated with the requested digital video asset, concatenate the segments together, and send the concatenated segments to a storage subsystem. The user may retrieve the segments from the storage subsystem.

However, if a large quantity of viewers requests a recording and/or the storage of the same digital video asset, the service assigned to that particular video stream may have to send a large quantity of requests to the segment recorder. If the service sends a large quantity of requests to the segment recorder, the service may become overloaded. For example, a compute node may be oversubscribed, ephemeral ports may be exhausted, timeout errors may occur, or the stored segments may not achieve near real-time latency. Thus, it may be desirable to provide a mechanism to avoid overloading the services.

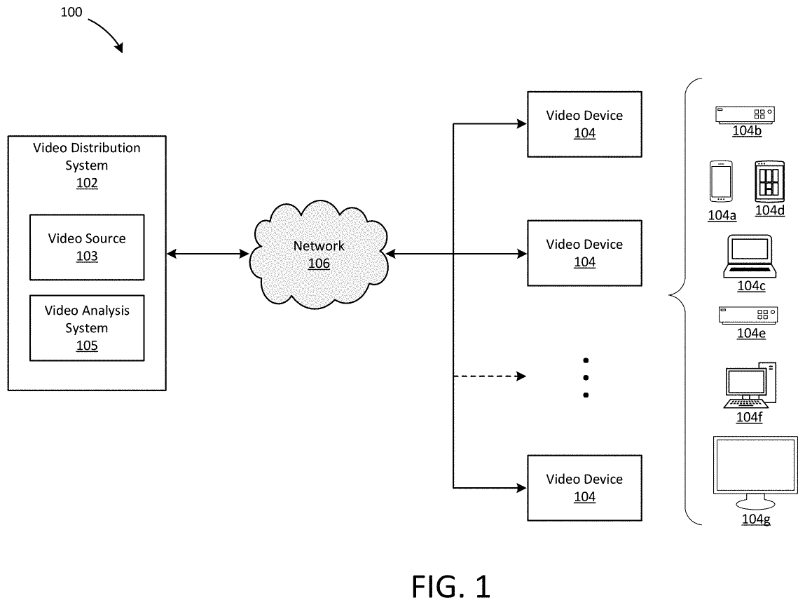

To avoid overloading the services, requests to record and/or store digital video assets may be split into batches. The batches may be evenly distributed amongst a plurality of services to minimize a likelihood of a service becoming overloaded. For example, if one service is overloaded, batches may be sent to a different service instead. Each of the batches may, for example, contain the same number of requests or a similar number of requests (e.g. within a particular range and/or satisfying a threshold). If each of the batches contains the same or a similar number of requests, storage of the digital video assets recordings may be optimized. FIG. 1 illustrates a block diagram of a system 100 in which the present systems, methods, and devices may be implemented. The system 100 comprises a video distribution system 102 and one or more video devices 104 configured to receive video content from a video source 103 of the video distribution system 102. The video devices 104 may receive the video content via a network 106.

As used herein, a digital video asset may refer generally to any video content produced for viewer consumption. A digital video asset may comprise video content produced for broadcast via over-the-air radio, cable, satellite, or the internet. A digital video asset may comprise video content produced for digital video streaming or video-on-demand. A digital video asset may comprise a television show or program. A digital video asset series may comprise two or more associated digital video asset. For example, a digital video asset series may include an episodic or serial television series. As another example, a digital video asset series may include a documentary series, such as a nature documentary series. As yet another example, a digital video asset series may include a regularly-scheduled digital video asset series, such as a nightly news program. Regardless of the type, format, genre, or delivery method of a digital video asset series, a digital video asset of the digital video asset series may be referred to generally as an episode of the digital video asset series.

A video device 104 may comprise any one of numerous types of devices configured to effectuate video playback and/or viewing. A video device 104 may comprise a display device, such as a television display 104g. A video device 104 may comprise a computing device, such as a laptop computer 104c or a desktop computer 104f. A video device 104 may comprise a mobile device, such as a smart phone 104a or a tablet computer 104d. A video device 104 may be configured to receive video content and output the video content to a separate display device for consumer viewing. For example, a video device 104 may comprise a set-top box 104e, such as a cable set-top box. A set-top box 104e may receive video content via a cable input (e.g., co-axial cable or fiber optic cable) and format the received video content for output to a display device. A set-top box 104e may receive video content via digital video streaming. A set-top box 104e (or other type of video device 104) may comprise a quadrature amplitude modulation (QAM) tuner. A set-top box 104e may comprise a digital media player or a gaming device.

A video device 104 may comprise a DVR 104b that receives and stores video content for later viewing. Other video devices 104 may also implement features that allow received video content to be stored on the device for later viewing. A video device 104 may be in communication with a cloud DVR system to receive video content. A video device 104 may combine any features or characteristics of the foregoing examples. For instance, a video device 104 may include a cable set-top box with integrated DVR features.

A video device 104 may be configured to receive viewer inputs relating to an introduction portion of a digital video asset or other duplicate or near-duplicate video content. For example, a video device 104 may be configured to receive viewer input to select an on-screen option or prompt to skip an introduction portion of a digital video asset. A video device 104 may be configured to receive viewer input to interact with on-screen advertisements or other interactive elements of video content.

The video distribution system 102 may generally effectuate video content delivery to the video devices 104. The video distribution system 102 may comprise a cable or satellite television provider system. A cable or satellite television provider system may deliver video content according to scheduled broadcast times and/or may implement video-on-demand services. The video distribution system 102 may comprise a digital video streaming system. The video distribution system 102 may implement a cloud-based DVR system configured to deliver “recorded” video content upon request from a video device 104.

The video distribution system 102 may comprise the video source 103. The video source 103 may provide (e.g., transmit or deliver) video content to the video devices 104. The video source 103 may comprise stored video content, such as that anticipated to be delivered as digital streaming video, on-demand video, or cloud DVR recorded video. The video source 103 may comprise video content intended for immediate or near-immediate broadcast, such as a live television video feed. For example, the video source 103 may comprise video content that has not yet been broadcast or made available for digital video streaming or on-demand video delivery. The video source 103 may comprise backhaul video content. The video source 103 may comprise stored reference introduction portions without the remainder portions of the respective digital video assets.

The video analysis system 105 may generally implement video analysis techniques relating to duplicate or near-duplicate video content (e.g., an introduction portion) between two or more instances of associated video content. The video analysis system 105 may base such analysis on video content at the video source 103, such as stored video content (e.g., for digital video streaming or on-demand delivery) or video content that is being delivered or soon will be delivered to video devices 104 (e.g., broadcast video programming). The video analysis system 105 may determine, based on reference video content, the segments of target video content that comprises the introduction portion of the target video content. Such a determination may be accomplished via a model (e.g., a machine learning model) that is configured to identify a portion of first video content (target video content) that visually corresponds to a portion of second video content (reference video content).

The network 106 may comprise a private portion. The network 106 may comprise a public portion, such as the Internet. The network 106 may comprise a content distribution and/or access network. The network 106 may comprise a cable television network. The network 106 may facilitate communication via one or more communication protocols. The network 106 may comprise fiber, cable, or a combination thereof. The network 106 may comprise wired links, wireless links, a combination thereof, and/or the like. The network 106 may comprise routers, switches, nodes, gateways, servers, modems, and/or the like.

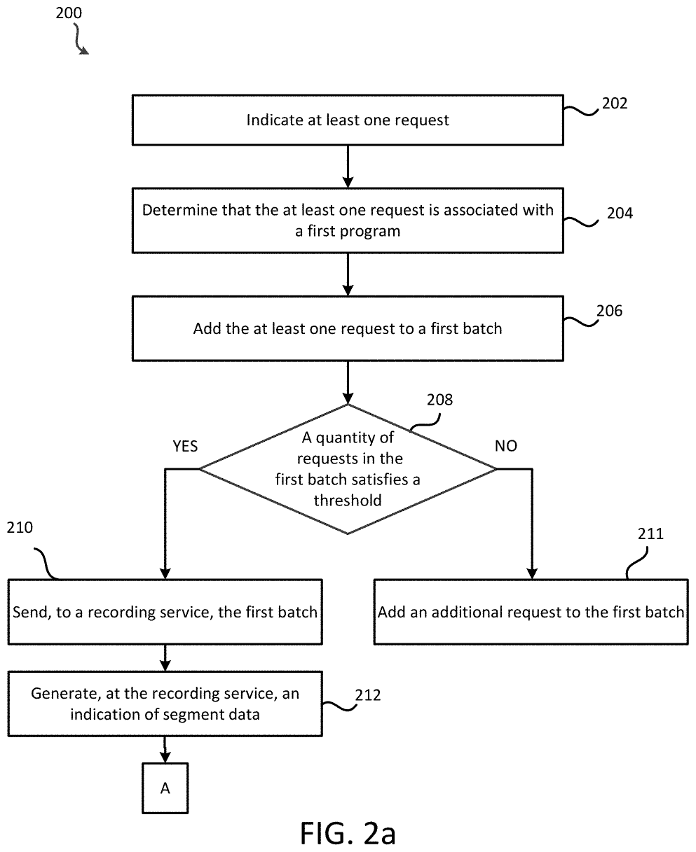

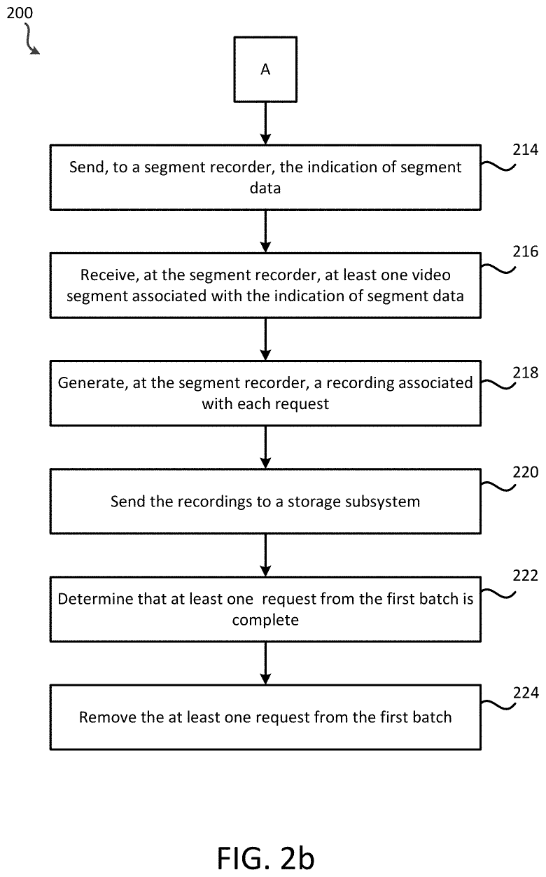

FIGS. 2a-b illustrate a flow diagram of an example method 200 for recording and/or storing digital video assets. Requests, such as recording and/or storage requests, may be received and split into batches. Each batch may comprise requests for a particular digital video asset. Each of the batches may, for example, contain the same number of requests or a similar number of requests (e.g. within a particular range and/or satisfying a threshold). If each of the batches contains the same or a similar number of requests, storage of the digital video assets recordings may be optimized. For example, if 1,000 viewers request a recording and/or the storage of a particular digital video asset, those 1,000 requests may be split into four different batches that each comprise 250 requests.

Data structures and metadata of each batch may be maintained. The data structures and metadata may be maintained, for example, by a stream coordinator. The batches may be maintained in a data structure such as an array. For example, the batches may be maintained in an array that grows and allows elements to be added from both sides of the queue, such as an ArrayDeqeue. If the batches are maintained in an array that grows and allows elements to be added from both sides of the queue, the array may have no capacity restrictions and may grow as necessary to support usage. As a result, the array may maintain as many batches as necessary.

As more requests are received to record and/or store a digital video asset, these requests may continue to be sorted into batches. The batch that comprises the smallest quantity of requests may be populated first. For example, if four batches are associated with a digital video asset, and they respectively comprise 150, 200, 235, and 249 requests, the batch comprising 150 requests may be populated first when new requests associated with that digital video asset are received. The batch with the smallest quantity of requests may sorted as the first element in the array. By sorting the batch with the smallest quantity of requests as the first element in the array, this may ensure that the batch gets populated first.

The end times of the requests in each batch may be maintained, for example, by the stream coordinator. The end time of a particular request may indicate a time at which the request for a digital video asset is complete. For example, the end times of the requests may be maintained in a data structure, such as a heap data structure. A heap data structure may be a binary tree that stores partially ordered values so that there is a relationship between the value stored at any node in the binary tree and the values of the node's children. For example, a min heap may be a type of heap data structure in which every node stores a value that is less than or equal to that of its children. Each stream may be associated with a min heap that maintains the end times of the requests belonging to that stream. An identification number associated with each batch may be maintained, for example, by the stream coordinator. Each batch may also be associated with an identification number, such as an internal recording identification number, that allows the stream coordinator to differentiate between different batches. A mapping, such as a HashMap, relating batch identification numbers to their respective batches may be maintained, for example, by the stream coordinator. If the mapping is a HashMap, the HashMap may store the identification numbers and their respective batches in “key/value” pairs. The mapping may also relate the identification numbers to the end times of the requests in their respective batches, such as the end times of the requests that reside in the min heap.

After all of the requests in a batch have been populated (e.g. the digital video asset associated with the requests has been recorded and/or stored), the batch may be repopulated with different requests to record and/or store the same digital video asset or a different digital video asset. A queue of batches that are available to be repopulated may be maintained. The queue of batches that are available to be repopulated may indicate which batches do not comprise any requests and are therefore available to be repopulated with requests.

A batch may enter the queue of batches available to be repopulated when it does not contain any requests, such as when all of the requests in the batch are complete. The request end times may be used to determine when the requests in a batch are complete. For example, a request may be complete when the end time of the request has been reached. When a request is complete, it may be removed from the batch that it is associated with. In order to efficiently remove completed requests from a batch, a timer associated with the batch may be set to the earliest recording end time associated with the batch. The earliest recording end time associated with the batch may be the earliest time at which a viewer has requested a recording of the digital video asset to end. By setting the timer to the latest recording end time, all of the requests in the batch with the same start time that end at the latest recording end time may be automatically evicted from the batch when the latest recording end time is reached. If a batch is added to the queue of batches available to be repopulated, it may be re-sorted as the first element in the array and it may be populated with requests for a particular digital video asset in the future. As discussed above, the batch sorted as the first element in the array may get populated with requests first.

If a quantity of requests in a batch satisfies a threshold, the batch may be sent to a service, such as a recording service (e.g. a manifest agent). For example, the batch may be sent to a batch recorder of a recording service by the stream coordinator. The threshold may be, for example, 250 requests, or may be any other number or range of numbers. The threshold may be determined based at least on a batch size that optimizes a storage subsystem of a system, such as the system 100. If a quantity of requests in a batch does not comply with the threshold, this may indicate that the batch is not full. For example, if the threshold is 250 requests, and a batch comprises 100 requests, the quantity of requests in this batch may not comply with the threshold and this batch may not be full. If the batch is not full, one or more additional requests may be added to the batch. For example, requests may continue to be added until the threshold is satisfied, or until there are no more requests associated with the digital video asset. The additional request(s) may be associated with the same program as the other requests in the batch. The batches may be evenly distributed amongst a plurality of services, such as recording services, to minimize a likelihood of a single service becoming overloaded.

Viewers may indicate a digital video asset or a portion of a digital video asset that they would like to record and/or store for later viewing. Referring to FIG. 2a, at step 202, at least one request may be indicated. Indicating the at least one request may comprise receiving, from a plurality of users, at least one request to record and/or store a digital video asset. For example, the at least one request may be received from the plurality of users at a computing device, such as one or more of the video devices 104 in FIG. 1. The computing device may be located external to a service, such as a recording service, associated with the digital video asset.

One or more of the requests may be associated with the same digital video asset. For example, one or more of the requests may be requests to record and/or store at least a portion of the same digital video asset, such as the same television program or movie. At step 204, it may be determined that the at least one request is associated with a digital video asset, such as a first digital video asset. Determining that the at least one request is associated with the digital video asset may comprise determining that an identification number associated with the at least one request is equal to or associated with an identification number associated with the digital video asset. Determining that the at least one request is associated with the digital video asset may comprise determining that a start time or an end time of the at least one request is associated with the digital video asset. The digital video asset may be associated with a stream. Requests that are associated with the same digital video asset may be added to or grouped together in the same batch. At step 206, the at least one request associated with the digital video asset may be added to or grouped together in at least one batch, such as a first batch. If a large number of requests are received for the same digital video asset, the requests may be split into multiple batches.

As discussed above, requests may be split into batches that contain the same number of requests or a similar number of requests (e.g. within a particular range and/or satisfying a threshold). If each of the batches contains the same or a similar number of requests, storage of the digital video assets may be optimized. At step 208 it may be determined whether a quantity of requests in the at least one batch, such as the first batch, satisfies a threshold. If the quantity of requests in the at least one batch satisfies the threshold, the method 200 may proceed to step 210. Determining that the quantity of requests in the at least one batch satisfies the threshold may comprise comparing the quantity of requests in the at least one batch to an optimal number of requests. The optimal number of requests may indicate an optimal number of requests in a batch to scale a storage subsystem or to optimize the performance of a compute node of a service, such as a recording service. The optimal number of requests in a batch may be a predetermined number. For example, the optimal number of requests in a batch may be 250 requests.

If the quantity of requests in the at least one batch is equal to or within a particular range of the optimal number of requests, the quantity of requests in the at least one batch may satisfy the threshold. The quantity of requests in the at least one batch may satisfy the threshold if no more users have requested a recording and/or storage of the digital video asset. For example, the quantity of requests in the first batch may satisfy the threshold if no more users have requested a recording and/or storage of the first digital video asset. If no more users have requested a recording and/or storage of the first digital video asset, there may be no more requests to add to the first batch. If there are no more requests to add to the first batch, the first batch may satisfy the threshold, even if it does not contain the optimal quantity of requests, so that the batch may be sent to a recording service, as discussed below at step 210. Conversely, if the quantity of requests in the at least one batch does not satisfy the threshold, the method 200 may proceed to step 211. At step 211, an additional request may be classified in or added to the at least one batch. Additional requests may be classified in or added to the at least one batch until the quantity of requests in the at least one batch is equal to or within a particular range of the optimal number of requests.

When the quantity of requests in the at least one batch satisfies the threshold, the at least one batch may be sent to a service, such as a recording service (e.g. manifest agent). At step 210, the at least one batch may be sent to a service associated with the digital video asset. The at least one batch may be sent to a batch recorder of a recording service associated with the digital video asset. For example, the first batch may be sent to a batch recorder of a recording service associated with the first digital video asset. At step 212, an indication of segment data for the requests in the at least one batch may be generated. The indication of segment data for the requests in the at least one batch may be generated at the service, such as at the batch recorder associated with a recording service. The indication of segment data for each of the requests in the at least one batch may comprise at least one of a start time, an end time, a duration, or an identification number.

The indication of segment data for the request in the at least one batch may be used, at least in part, by a segment recorder to generate recordings and/or store recordings associated with the requests in the at least one batch. Continuing to FIG. 2b, at step 214, the indication of segment data for the requests in the at least one batch may be sent to a segment recorder. As discussed above, segment recorders may receive requests from the service, fetch at least one segment associated with the requested digital video asset, concatenate the segments together, and send the concatenated segments to a storage subsystem. At step 216, at least one segment, such as an audio segment or a video segment, associated with the indication of segment data may be received. The at least one segment associated with the indication of segment data may be received at the segment recorder. At step 218, a recording associated with each request in the at least one batch may be generated. A unique copy may be generated for each request. Additionally, or alternatively, a common copy may be created for all requests in the at least one batch along with a user-specific portion generated for each individual request. Each recording may be generated at the segment recorder and each recording may be generated based on the indication of segment data. For example, each recording may be generated based on the at least one segment associated with the indication of segment data. At step 220, each recording, such as each of the unique copies or the common copy along with user-specific portions, may be sent to a storage subsystem. Each recording may be sent to the storage subsystem by the segment recorder. The storage subsystem may be in a location that is remote to the segment recorder. The plurality of users may retrieve the recordings from the storage subsystem.

After recordings associated with the requests in the batch are sent to the storage subsystem, those requests may be complete. At step 222, it may be determined that at least one request from the at least one batch is complete. For example, it may be determined that a recording associated with at least one request from the at least one batch has been sent to the storage subsystem. At step 224, the at least one complete request may be removed from the at least one batch. For example, a quantity of requests in the at least one batch may be decreased. As discussed above, if the batch is empty (e.g. contains no more requests) after the at least one completed request is removed from the batch, the batch may be eligible to be repopulated with different requests to record and/or store the same digital video asset or a different digital video asset. If the batch is eligible to be repopulated, it may be added to a queue of batches that are available to be repopulated. If a batch is added to the queue of batches available to be repopulated, it may be re-sorted as the first element in an array and may get populated with requests first.

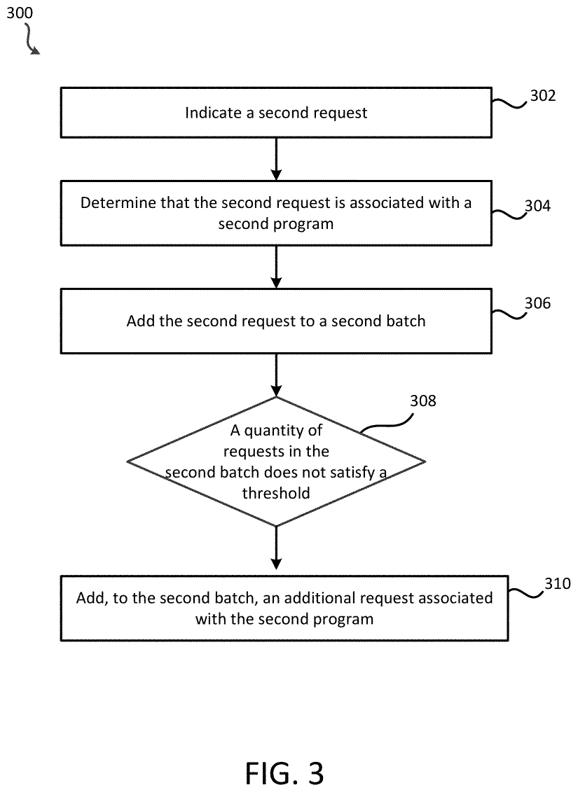

As discussed above with respect to method 200, requests in the at least one batch may be associated with the same, first digital video asset (e.g. may be requests to record and/or store at least a portion of the same television program or movie). Requests associated with a different digital video asset may be added to or grouped together in a different batch. FIG. 3 illustrates a flow diagram of an example method 300 for recording and/or storing digital video assets, such as digital video assets that are different than the digital video asset described above with respect to method 200.

Viewers may indicate a digital video asset or a portion of a different digital video asset that they would like to record and/or store for later viewing. At step 302, a second request may be indicated. Indicating the second request may comprise receiving, from a plurality of users, at least one request to record at least a portion of a digital video asset, such as a second digital video asset. The second digital video asset may be different than the first digital video asset described above with respect to method 200. For example, the at least one request may be received from the plurality of users at a computing device, such as one or more of the video devices 104 in FIG. 1. The computing device may be located external to a service, such as a recording service, associated with the digital video asset.

The second request may be a request to record and/or store at least a portion of the second digital video asset. At step 304, it may be determined that the second request is associated with a second digital video asset. Determining that the second request is associated with the second digital video asset may comprise determining that an identification number associated with the second request is equal to or associated with an identification number associated with the second digital video asset. Determining that the second request is associated with the digital video asset may comprise determining that a start time or an end time of the second request is associated with the second digital video asset. The second digital video asset may be associated with a stream.

As discussed above, requests that are associated with the same digital video asset may be added to or grouped together in the same batch. At step 306, the second request may be added to a second batch. The second batch may be associated with the second digital video asset. The second batch may already comprise other requests for recording and/or storage of the second digital video asset, or the second request may be the first request added to the second batch. Adding the second request to the second batch may be based on the determination that the second request is associated with the second program. Adding the second request to the second batch may comprise grouping requests for the second program, received from a plurality of users, in the second batch.

As discussed above, if the quantity of requests in a batch does not satisfy a threshold, one or more additional requests may be classified in or added to that batch. At step 308 it may be determined that a quantity of requests in the second batch does not satisfy a threshold, such as the threshold described above with respect to method 200. The quantity of requests in the second batch may not satisfy the threshold if the quantity of requests in the second batch is less than or not within a range of an optimal quantity of requests. The quantity of requests in the at least one batch may not satisfy the threshold if the quantity of requests in the second batch is less than or not within a range of an optimal quantity of requests and more users have requested a recording and/or storage of the second digital video asset. For example, the quantity of requests in the second batch may not satisfy the threshold if there are less than 250 requests in the second batch and if more users have requested a recording and/or storage of the second digital video asset. For example, determining that the quantity of requests in the second batch does not comply with the threshold may comprise comparing the quantity of requests in the second batch to the optimal number of requests. The optimal number of requests may indicate an optimal number of requests in a batch to scale a storage subsystem. The optimal number of requests in a batch may be a predetermined number. For example, the optimal number of requests in a batch may be 250.

Additional requests may be classified in or added to the second batch until the quantity of requests in the second batch is equal to or within a particular range of the optimal number of requests. At step 310, an additional request associated with the second digital video asset may be added to the second batch. When the quantity of requests in the second batch satisfies the threshold, the second batch may be sent to a service, such as a recording service (e.g. manifest agent). The second batch may be sent to a service associated with the second digital video asset. The second batch may be sent to a batch recorder of a recording service associated with the second digital video asset. For example, the second batch may be sent to a batch recorder of a recording service associated with the second digital video asset. An indication of segment data for the requests in the second batch may be generated. The indication of segment data for the requests in the second batch may be generated at the service, such as at the batch recorder associated with a recording service. The indication of segment data for each of the requests in the second batch may comprise at least one of a start time, an end time, a duration, or an identification number.

The indication of segment data for the requests in the second batch may be used, at least in part, by a segment recorder to generate recordings and/or store recordings associated with the requests in the second batch. The indication of segment data for the requests in the second batch may be sent to a segment recorder. As discussed above, segment recorders may receive requests from the service, fetch at least one segment associated with the requested digital video asset, concatenate the segments together, and send the concatenated segments to a storage subsystem. At least one segment, such as an audio segment or a video segment, associated with the indication of segment data may be received. The at least one segment associated with the indication of segment data may be received at the segment recorder. A recording associated with each request in the second batch may be generated. A unique copy may be generated for each request in the second batch. Additionally, or alternatively, a common copy may be created for all requests in the second batch along with a user-specific portion generated for each individual request. Each recording, such as each of the unique copies or the common copy along with user-specific portions, may be sent to a storage subsystem by the segment recorder. The storage subsystem may be in a location that is remote to the segment recorder. The plurality of users may retrieve the recordings from the storage subsystem.

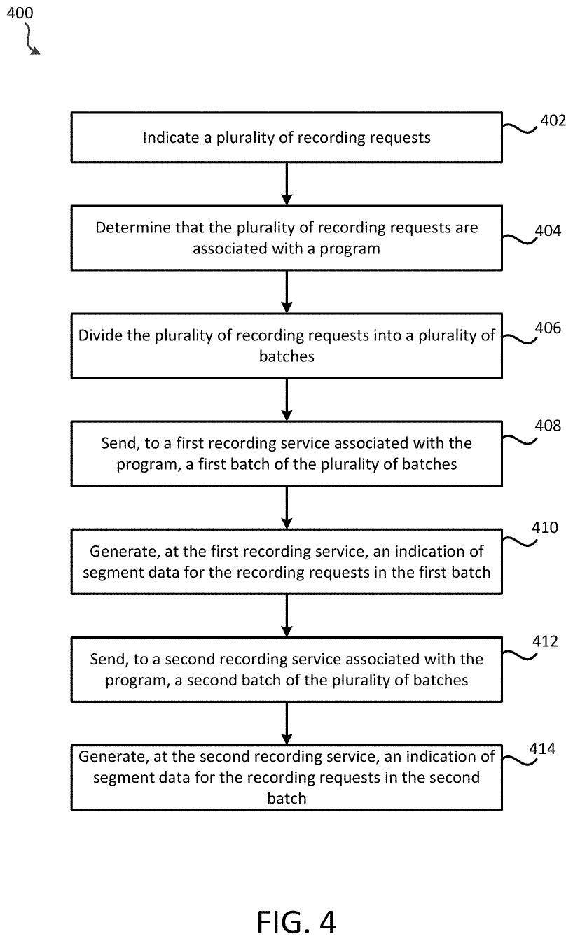

If a large number of requests are received for the same digital video asset, the requests may be sorted into multiple batches. This may occur, for example, if a particular digital video asset is particularly popular, such as a season finale of a popular television program. A large number of viewers may request the recording and/or storage of at least a portion of this digital video asset. This may result in a large number of requests, such as a number of requests that exceeds an optimal number of requests in a single batch. If the number of requests exceeds the optimal number of requests for a single batch, the requests may be sorted into a plurality of batches. FIG. 4 illustrates a flow diagram of an example method 400 for recording and/or storing digital video assets. A plurality of services, such as recording services (e.g. manifest agents), may be associated with the same digital video asset, such as the same television program or the same movie. Each recording service may receive batches of requests for recording and/or storage of the same digital video asset. The requests associated with the same digital video asset may be added to a plurality of batches. Each of the plurality of batches may comprise the same quantity of requests, such as an optimal number of recordings, or a similar number of requests (e.g. within a particular range and/or satisfying a threshold). The plurality of batches may be evenly distributed amongst the plurality of services, such as recording services (e.g. manifest agents) associated with the digital video asset. By distributing the batches evenly amongst the plurality of services, the workload on a single service may be minimized and/or a likelihood of a single recording service becoming overloaded may be minimized.

Data structures and metadata of each batch of the plurality may be maintained. The data structures and metadata may be maintained, for example, by a stream coordinator. The plurality of batches may be maintained in a data structure such as an array. For example, the batches may be maintained in an array that grows and allows elements to be added from both sides of the queue, such as an ArrayDeqeue. If the plurality of batches are maintained in an array that grows and allows elements to be added from both sides of the queue, the array may have no capacity restrictions and may grow as necessary to support usage. As a result, the array may maintain as many batches as necessary.

As more requests are received to record and/or store a digital video asset, these requests may continue to be sorted into the plurality of batches. The batch of the plurality that comprises the smallest quantity of requests may be populated first. For example, if four batches are associated with a digital video asset, and they respectively comprise 150, 200, 235, and 249 requests, the batch comprising 150 requests may be populated first when new requests associated with that digital video asset are received. The batch with the smallest quantity of requests may sorted as the first element in the array. By sorting the batch with the smallest quantity of requests as the first element in the array, this may ensure that the batch gets populated first.

The end times of the requests in each batch may be maintained, for example, by the stream coordinator. The end time of a particular request may indicate a time at which the request for a digital video asset is complete. For example, the end times of the requests may be maintained in a data structure, such as a heap data structure. A heap data structure may be a binary tree that stores partially ordered values so that there is a relationship between the value stored at any node in the binary tree and the values of the node's children. For example, a min heap may be a type of heap data structure in which every node stores a value that is less than or equal to that of its children. Each stream may be associated with a min heap that maintains the end times of the requests belonging to that stream. An identification number associated with each batch may be maintained, for example, by the stream coordinator. Each batch may also be associated with an identification number, such as an internal recording identification number, that allows the stream coordinator to differentiate between different batches. A mapping, such as a HashMap, relating batch identification numbers to their respective batches may be maintained, for example, by the stream coordinator. If the mapping is a HashMap, the HashMap may store the identification numbers and their respective batches in “key/value” pairs. The mapping may also relate the identification numbers to the end times of the requests in their respective batches, such as the end times of the requests that reside in the min heap.

After all of the requests in a batch have been fulfilled (e.g. the digital video asset associated with the requests has been recorded and/or stored), the batch may be repopulated with different requests to record and/or store the same digital video asset or a different digital video asset. A queue of batches that are available to be repopulated may be maintained. The queue of batches that are available to be repopulated may indicate which batches do not comprise any requests and are therefore available to be repopulated with requests.

A batch may enter the queue of batches available to be repopulated when it does not contain any requests, such as when all of the requests in the batch are complete. The request end times may be used to determine when the requests in a batch are complete. For example, a request may be complete when the end time of the request has been reached. When a request is complete, it may be removed from the batch that it is associated with. In order to efficiently remove completed requests from a batch, a timer associated with the batch may be set to the earliest recording end time associated with the batch. The earliest recording end time associated with the batch may be the earliest time at which a viewer has requested a recording of the digital video asset to end. By setting the timer to the earliest recording end time, all of the requests in the batch with the same start time may be evicted from the batch when the earliest recording end time is reached. If a batch is added to the queue of batches available to be repopulated, it may be re-sorted as the first element in the array and it may be populated with requests for a particular digital video asset in the future. As discussed above, the batch sorted as the first element in the array may get populated with requests first.

If a quantity of requests in a batch satisfies a threshold, the batch may be sent to a service, such as a recording service (e.g. a manifest agent). For example, the batch may be sent to a batch recorder of a recording service by the stream coordinator. The threshold may be, for example, 250 requests, or may be any other number or range of numbers. The threshold may be determined based at least on a batch size that optimizes a storage subsystem of a system, such as the system 100. If a quantity of requests in a batch does not comply with the threshold, this may indicate that the batch is not full. For example, if the threshold is 250 requests, and a batch comprises 100 requests, the quantity of requests in this batch may not comply with the threshold and this batch may not be full. If the batch is not full, one or more additional requests may be added to the batch. For example, requests may continue to be added until the threshold is satisfied, or until there are no more requests associated with the digital video asset. The additional request(s) may be associated with the same program as the other requests in the batch. The batches may be evenly distributed amongst a plurality of services, such as recording services, to minimize a likelihood of a single service becoming overloaded.

Viewers may indicate a digital video asset or a portion of a digital video asset that they would like to record and/or store for later viewing. At step 402, a plurality of requests may be indicated. Indicating the plurality of requests may comprise receiving, from a plurality of users, a request to record and/or store at least a portion of a digital video asset. For example, the plurality of requests may be received from the plurality of users at a computing device, such as one or more of the video devices 104 in FIG. 1. The computing device may be located external to a service, such as a recording service, associated with the digital video asset. The number of requests in the plurality may be large, such as a number that exceeds an optimal number of requests for a single batch.

At least a subset of the plurality of requests may be associated with the same digital asset, such as a series finale of a popular television show. At step 404, it may be determined that at least a subset of the plurality of requests are associated with a single digital video asset. Determining that the plurality of requests are associated with the digital video asset may comprise determining that an identification number associated with each of the plurality of requests is equal to or associated with an identification number associated with the digital video asset. Determining that the plurality of requests are associated with the digital video asset may comprise determining that a start time or an end time of each of the plurality of requests is associated with the digital video asset. The digital video asset may be associated with a stream.

If the number of requests in at least the subset of the plurality of requests is a large number of requests, such as a number that exceeds an optimal number of requests for a single batch, the requests may be sorted into a plurality of batches. At step 406, at least the subset of the plurality of requests may be divided into a plurality of batches. The plurality of batches may, for example, comprise at least a first batch and a second batch. It may be desirable for each of the plurality of batches to comprise the optimal number of requests for a batch, and/or to comprise a quantity of requests within a particular range of the optimal number of requests. For example, if the optimal number of requests for a batch is 250 requests, it may be desirable for each batch in the plurality to comprise 250, or close to 250, requests. If each of the plurality of requests comprises a quantity of requests close to or equal to the optimal number of requests, the eventual storage of the recordings associated with the requests may be optimized.

If one or more of the first batch or the second batch do not comprise the optimal number of requests, or a quantity of requests within a range of the optimal number of requests, at least one additional request associated with the digital video asset may be added to at least one of the first batch or the second batch. For example, if the first batch comprises the optimal number of requests, or a quantity of requests within a range of the optimal number of requests, and the second batch does not comprise the optimal number of requests, or a quantity of requests within a range of the optimal number of requests, at least one additional request associated with the digital video asset may be added to the second batch but not to the first batch (or vice versa). If neither the first batch nor the second batch comprise the optimal number of requests, or a quantity of requests within a range of the optimal number of requests, at least one additional request associated with the digital video asset may be added to both the first batch and the second batch. Adding additional request to one or more of the first batch or second batch may ensure that each of the plurality of batches to comprise the optimal number of requests for a batch, and/or to comprise a quantity of requests within a particular range of the optimal number of requests. This may optimize the eventual storage of the recordings associated with the requests.

As discussed above, the batches may be maintained in a data structure such as an array. The batch with the smallest quantity of requests may sorted as the first element in the array. By sorting the batch with the smallest quantity of requests as the first element in the array, this may ensure that the batch gets populated first. For example, if the second batch comprises fewer requests than the first batch, the second batch may be sorted as the first element in the array. Additional requests associated with the same digital video asset may be added to the batch comprising the smallest quantity of requests, such as the batch sorted as the first element in the array. If the second batch comprises the smallest quantity of requests, an additional request associated with the digital video asset may be added to the second batch. Additional requests may be classified in or added to the second batch until the quantity of requests in the second batch comprises the optimal number of requests, or a quantity of requests within a range of the optimal number of requests.

A plurality of services, such as recording services (e.g. manifest agents), may be associated with the digital video asset. Each service may receive batches of requests for recording and/or storage of the same digital video asset. The plurality of batches may be evenly distributed amongst the plurality of services, such as recording services (e.g. manifest agents) associated with the digital video asset. By distributing the batches evenly amongst the plurality of services, the workload on a single service may be minimized and/or a likelihood of a single recording service becoming overloaded may be minimized.

If the first batch and the second batch each comprise the optimal number of requests, or a quantity of requests within a range of the optimal number of requests, the first batch and second batch may each be sent to a service, such as a recording service (e.g. manifest agent) associated with the digital video asset. The first batch and second batch may be sent to the same service, or to different services. For example, the first batch may be sent to a first recording service associated with the digital video asset and the second batch may be sent to a second recording service associated with the digital video asset. The first and second batches may be sent to the first and second services, for example, by the stream coordinator. By sending batches associated with the same digital video asset to a plurality of services, the workload on any one service may be minimized and the risk of a single service becoming overloaded may be minimized.

At step 408, the first batch may be sent to a first service, such as a first recording service (e.g. first manifest agent) associated with the digital video asset. The first service may comprise a first batch recorder. At step 410, an indication of segment data may be generated for the requests in the first batch. The indication of segment data may be generated at the first service. For example, the indication of segment data may be generated at the first batch recorder. The indication of segment data for the requests in the first batch may comprise at least one of a start time, an end time, a duration, or an identification number. At step 412, the second batch may be sent to a second service, such as a second recording service (e.g. second manifest agent) associated with the digital video asset. The second service may comprise a second batch recorder. For example, the second batch may be sent to the second service, instead of the first service, if the first service is overloaded with batches. At step 414, an indication of segment data may be generated for the requests in the second batch. The indication of segment data may be generated at the second service. For example, the indication of segment data may be generated at the second batch recorder. The indication of segment data for the requests in the second batch may comprise at least one of a start time, an end time, a duration, or an identification number.

The indication of segment data for the requests in the first and second batches may be used, at least in part, by one or more segment recorders to generate recordings and/or store recordings associated with the requests in the first and second batches. The indication of segment data for the requests in the first batch and second batch may be sent to one or more segment recorders. As discussed above, segment recorders may receive requests from a service, fetch at least one segment associated with the requested digital video asset, concatenate the segments together, and send the concatenated segments to a storage subsystem. At least one segment, such as an audio segment or a video segment, associated with the indication of segment data may be received. The at least one segment associated with the indication of segment data may be received at the segment recorder(s). A recording associated with each request in the first batch and second batch may be generated. A unique copy may be generated for each request in the first batch and second batch. Additionally, or alternatively, a common copy may be created for all requests in the first and second batch along with a user-specific portion generated for each individual request. Each recording, such as each of the unique copies or the common copy along with user-specific portions, may be sent to a storage subsystem by the segment recorder(s). The storage subsystem may be in a location that is remote to the segment recorder(s). The plurality of users may retrieve the recordings from the storage subsystem.

As described above, the plurality of batches may be maintained in an array and the batch with the smallest quantity of requests may be the first element in the array. While this approach is favorable due to the simplicity of maintaining recording metadata with a given batch for the life of a recording, batches may also be collapsed in order to further optimize batch density. It may be periodically determined whether at least one batch, such as the batches that are the first elements in the array, have satisfied a threshold, such as the maximum number of recordings. For example, it may be determined whether at least one batch at the top of the list has satisfied the threshold every 5 or 10 minutes, or at the hour when programming starts and ends. If the threshold has not been satisfied, the recording metadata may be moved into other batches to increase the occupancy or density of the batches.

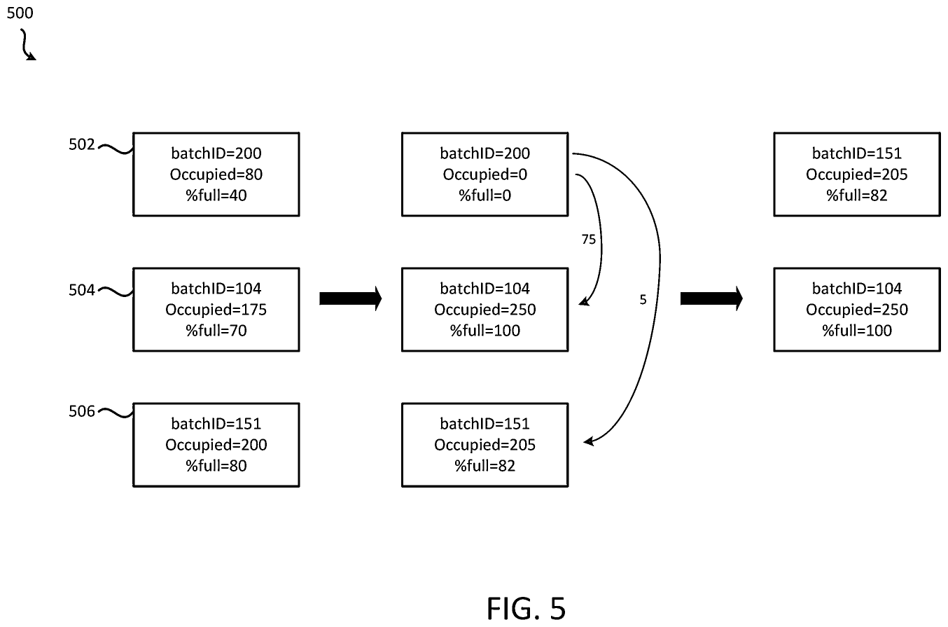

For example, referring to FIG. 5, if a first batch 502 in an array comprises 80 requests and the optimal quantity of requests in a batch is 250 requests, the first batch 502 may not satisfy the threshold. The first batch 502 is only at a 40% population rate. If a second batch 504 in the array comprises 175 requests, the second batch 504 also may not satisfy the threshold. The second batch 504 is only at a 70% population rate. If a third batch 506 in the array comprises 200 requests, it also may not satisfy the threshold and is only at an 80% population rate. Instead of waiting for new requests and populating the first batch 502 when the new requests are received, requests may be moved from the first batch 502 to the second batch 504, until the quantity of requests in the second batch satisfies the threshold. For example, 75 requests may be moved from the first batch 502 to the second batch 504, so that the second batch 504 comprises 250 requests. Once the quantity of requests in the second batch 504 satisfies the threshold (e.g. % full=100), the remaining requests in the first batch 502 may be moved to the third batch 506. For example, the remaining 5 requests in the first batch 502 may be moved to the third batch 506 so that the third batch 506 now comprises 205 requests. Now that the first batch 502 comprises no requests, it may be reusable. The array of batches may be resorted so that the third batch becomes the first element in the array. The first batch 502, which no longer comprises requests, may be removed from the array and added to a queue of batches that may be repopulated at a later time. By sorting the third batch 506 (e.g. the batch with the smallest quantity of requests) as the first element in the array, this may ensure that the third batch 506 gets populated first.

After moving all of the requests out of the first batch, the algorithm may repeat itself. For example, after moving all of the requests out of the first batch, the algorithm may check whether the new first element in the array, such as the third batch, comprises a quantity of requests that satisfies the threshold. When movement to each new batch is complete, a command, such as a Moved comment, may be sent to a service, such as a recording service (e.g. manifest agent). The command may result in the eviction of the recording metadata state in the origin batch and the initialization of the recording metadata state in the receiving batch.

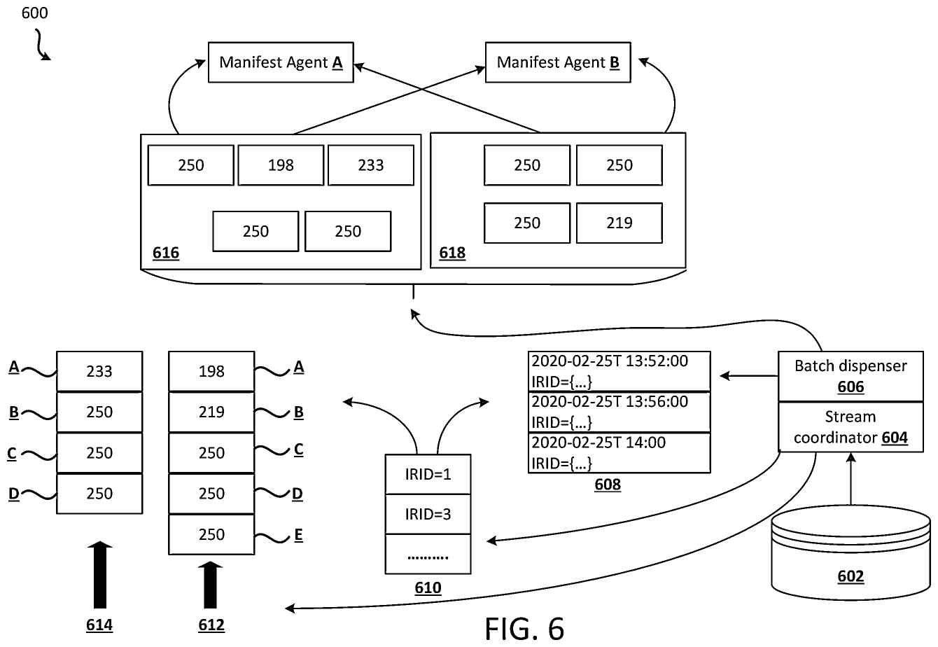

FIG. 6 shows an example system 600 for maintaining the data structure and metadata of each batch. The data structures and metadata may be maintained, for example, by a stream coordinator 604. The stream coordinator 604 may identify requests for recording and/or storage that have been received from viewers. For example, the stream coordinator 604 may poll a schedule associated with one or more streams, such as A&E and/or NBC, to identify requests for recording and/or storage that have been received from viewers for that stream. This schedule data polled by the stream coordinator 604 may be stored in a storage subsystem, such as the database 602. The stream coordinator 604 may then use the techniques described above with respect to FIGS. 2-5, to send batches to services, such as recording services (e.g. manifest agents).

The stream coordinator 604 may maintain the end times of the requests in each batch. The end time of a particular request may indicate a time at which the request for a digital video asset is complete. For example, the end times of the requests may be maintained in a data structure 608. The data structure 608 may be, for example, a heap data structure. A heap data structure may be a binary tree that stores partially ordered values so that there is a relationship between the value stored at any node in the binary tree and the values of the node's children. For example, a min heap may be a type of heap data structure in which every node stores a value that is less than or equal to that of its children. Each stream may be associated with a min heap that maintains the end times of the requests belonging to that stream.

The stream coordinator 604 may maintain an identification number associated with each batch. Each batch may also be associated with an identification number, such as an internal recording identification number, that allows the stream coordinator to differentiate between different batches. For example, the stream coordinator 604 may maintain the identification numbers in a mapping 610, such as a HashMap, that relates batch identification numbers to their respective batches. If the mapping 610 is a HashMap, the mapping 610 may store the identification numbers and their respective batches in “key/value” pairs. The mapping 610 may also relate the identification numbers to the end times of the requests in their respective batches, such as the end times of the requests that reside in the data structure 608.

The stream coordinator 604 may maintain the batches in a data structure such as an array. For example, the stream coordinator 604 may maintain the batches in arrays 612 and 614. For example, the batches may be maintained in an array that grows and allows elements to be added from both sides of the queue, such as an ArrayDeqeue. If the batches are maintained in an array that grows and allows elements to be added from both sides of the queue, the array may have no capacity restrictions and may grow as necessary to support usage. As a result, the array may maintain as many batches as necessary.

The arrays maintained by the stream coordinator 604 may each be associated with a particular stream. For example, the array 612 may be associated with a first stream, such as A&E, and the array 614 may be associated with a second stream. The second stream may be a different stream, such as NBC. Each batch of requests in a particular array may be associated with that stream. For example, batches 614a-d may be associated with the first stream and batches 612a-e may be associated with the second stream. If a batch is associated with a stream, the batch may comprise requests from viewers to record and/or store at least a portion of a digital video asset, such as a television show or move, associated with that stream.

Each batch in each array 612, 614 may comprise requests. The stream coordinator 604 may perform the techniques described above with respect to FIGS. 2-5 to add and/or classify requests into the batches. Each batch in each array 612, 614 may comprise a quantity of requests. The quantity of requests in one or more batches in each array 612, 614 may be an optimal number of requests in a batch to scale a storage subsystem, such as database 602, or to optimize the performance of a compute node of a service, such as a recording service. The optimal number of requests in a batch may be a predetermined number. For example, the optimal number of requests in a batch may be 250 requests. The quantity of requests in one or more batches in each array 612, 614 may alternatively, or additionally, be within a particular range of the optimal number of requests, such as within a particular range of 250 requests.

As discussed above, the batch with the smallest quantity of requests may sorted as the first element in the arrays 612, 614. For example, in array 614, the batch 614A comprises the smallest quantity of requests (233 requests). Similarly, in array 612, the batch 612a comprises the smallest quantity of requests (198 requests). The batch 612b, which comprises the next smallest quantity of requests (219 requests) is sorted as the second element in the array. By sorting the batch with the smallest quantity of requests as the first element in the array, this may ensure that the batch gets populated first. Additional requests associated with the same digital video asset may be added to the batch comprising the smallest quantity of requests, such as the batch sorted as the first element in the array. Additional requests may be classified in or added to the batch until the quantity of requests in the batch comprises the optimal number of requests, or a quantity of requests within a range of the optimal number of requests.

A plurality of services, such as recording services (e.g. manifest agents A and B) may be associated with the digital video asset. Each service may be associated with one or more batch recorders 616, 618. A batch dispenser 606 may send, to the batch recorders 616, 618 the batches of requests from the arrays 612, 614. The plurality of batches 612a-e and 614a-d may be evenly distributed amongst the batch recorders 616, 618. By distributing the batches evenly amongst the batch recorders 616, 618, the workload on a single service may be minimized and/or a likelihood of a single recording service becoming overloaded may be minimized. Distributing the batches evenly amongst the batch recorders may comprise sending some batches associated with a first stream to the same batch recorder as batches associated with a different, second stream. For example, batch 612a and 612b are sent to different batch recorders (batch 612a is sent to batch recorder 616, whereas batch 612b is sent to batch recorder 618. Batch 612a is sent to a batch recorder, such as batch recorder 616, that also receives batches stored in different arrays (e.g. batches associated with different streams), such as batch 614a stored in array 614. Likewise, batch 612b is sent to batch recorder, such as batch recorder 618, that also receives batches stored in different arrays (e.g. batches associated with different streams), such as batch 614b stored in array 614.

For example, if a particular stream, such as the stream associated with array 612, was streaming a popular television program one evening, a large number of requests may be received from viewers to record and/or store at least a portion of that television program. For example, the number of requests may be large enough where the requests could populate 100 batches of 250 requests each. If all of the requests associated with a stream had to be sent to a single batch recorder, that batch recorder may become overloaded. By sending the batches in array 612 to different batch recorders, the workload associated with the requests for the popular television program may be split amongst multiple batch recorders, thus avoiding service overload.

The assigned service, such as the assigned batch recorder 616 or 618, may send a request to a segment recorder. The request may comprise the data and/or metadata associated with the digital video asset, such as the data and/or metadata stored in data structures 608. The segment recorder may receive the request from the service, fetch at least one segment associated with the requested digital video asset, concatenate the segments together, and send the concatenated segments to a storage subsystem. The user may retrieve the segments from the storage subsystem.

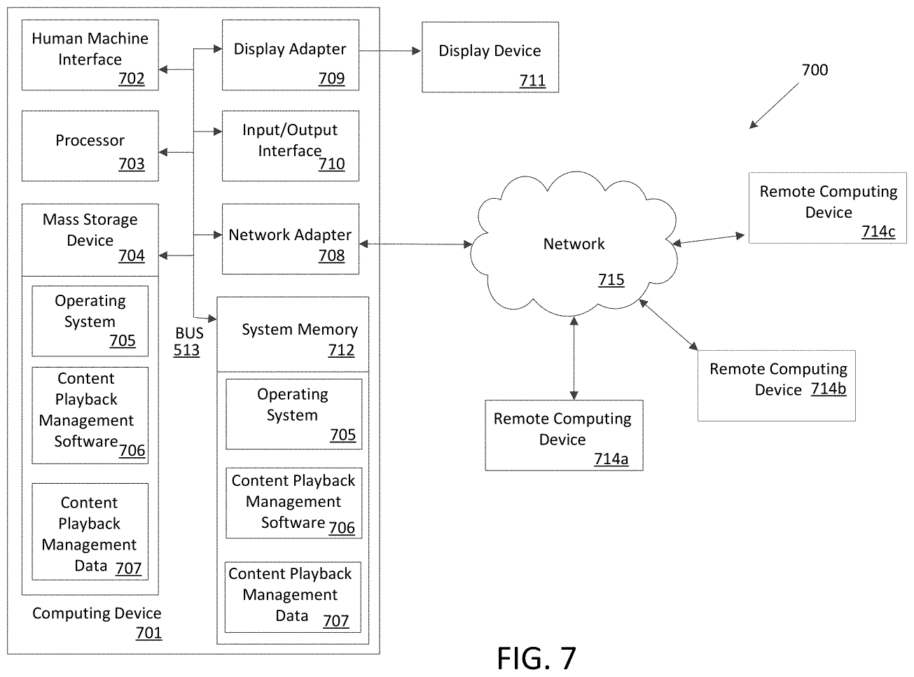

FIG. 7 shows an example system 700. The system 700 may comprise a computing device 701. The computing device 701 may comprise one or more of the devices in FIG. 1, such as the one or more video devices 104. The computing device 701 may comprise a system bus 713. The system bus 713 may comprise one or more bus structures, including a memory bus or memory controller, a peripheral bus, an accelerated graphics port, and a processor or local bus using any of a variety of bus architectures. The architectures may comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The system bus 713, and all buses specified in this description may also be implemented over a wired or wireless network connection and each of the subsystems, including the processing unit 703, a mass storage device 704, an operating system 705, content playback management software 706, content playback management data 707, a network adapter 708, system memory 712, an Input/Output Interface 710, a display adapter 709, a display device 711, and a human machine interface 702, may be contained within one or more remote computing devices 714a,b,c at physically separate locations, connected through buses of this form, in effect implementing a fully distributed system.

The computing device 701 may comprise a variety of computer readable media. Exemplary readable media may be any available media that is accessible by the computing device 701 and comprises, for example and not meant to be limiting, both volatile and non-volatile media, removable and non-removable media. The system memory 712 may comprise the intelligent cache. The system memory 712 comprises computer readable media in the form of volatile memory, such as random-access memory (RAM), and/or non-volatile memory, such as read only memory (ROM). The system memory 712 may store data such as content playback management data 707 and/or program modules such as operating system 705 and content playback management software 706 that are immediately accessible to and/or are presently operated on by the processing unit 503.

The computing device 701 may comprise other removable/non-removable, volatile/non-volatile computer storage media. FIG. 7 shows a mass storage device 704 which may provide non-volatile storage of computer code, computer readable instructions, data structures, program modules, and other data for the computing device 701. For example and not meant to be limiting, a mass storage device 704 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules may be stored in the mass storage device 704, including for example, an operating system 705 and content playback management software 706. Each of the operating system 705 and content playback management software 706 (or some combination thereof) may comprise elements of the programming and the content playback management software 706. Content playback management data 707 may also be stored in the mass storage device 704. Content playback management data 707 may be stored in any of one or more databases known in the art. Examples of such databases comprise, DB2®, Microsoft® Access, Microsoft® SQL Server, Oracle®, mySQL, PostgreSQL, and the like. The databases may be centralized or distributed across multiple systems.

The user may enter commands and information into the computing device 701 via an input device (not shown). Examples of such input devices comprise, but are not limited to, a keyboard, a pointing device (e.g., a “mouse”), a microphone, a joystick, a scanner, tactile input devices such as gloves, and other body coverings, and the like. These and other input devices may be connected to the processing unit 703 via a human machine interface 702 that is coupled to the system bus 713, but may be connected by other interface and bus structures, such as a parallel port, game port, an IEEE 1394 Port (also known as a Firewire port), a serial port, or a universal serial bus (USB).

A display device 711 may also be connected to the system bus 713 via an interface, such as a display adapter 709. It is contemplated that the computing device 701 may have more than one display adapter 709 and the computing device 701 may have more than one display device 711. For example, a display device may be a monitor, an LCD (Liquid Crystal Display), or a projector. In addition to the display device 711, other output peripheral devices may comprise components such as speakers (not shown) and a printer (not shown) which may be connected to the computing device 701 via Input/Output Interface 710. Any step and/or result of the methods may be output in any form to an output device. Such output may be any form of visual representation, including, but not limited to, textual, graphical, animation, audio, tactile, and the like. The display device 711 and computing device 701 may be part of one device, or separate devices.

The computing device 701 may operate in a networked environment using logical connections to one or more remote computing devices 714a,b,c. The remote computing devices 714a,b,c, may comprise one or more of the video devices 104 in FIG. 1. A remote computing device may be a personal computer, portable computer, a smart phone, a server, a router, a network computer, a peer device or other common network node, and so on. Logical connections between the computing device 701 and a remote computing device 714a,b,c may be made via a network 715, such as a local area network (LAN) and a general wide area network (WAN). Such network connections may be through a network adapter 708. A network adapter 708 may be implemented in both wired and wireless environments. Such networking environments are conventional and commonplace in dwellings, offices, enterprise-wide computer networks, intranets, and the Internet.

Application programs and other executable program components such as the operating system 705 are shown herein as discrete blocks, although it is recognized that such programs and components reside at various times in different storage components of the computing device 701 and are executed by the data processor(s) of the computer. An implementation of content playback management software 706 may be stored in or sent across some form of computer readable media. Any of the disclosed methods may be performed by computer readable instructions embodied on computer readable media. Computer readable media may be any available media that may be accessed by a computer. For example, and not meant to be limiting, computer readable media may comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

It is to be understood that the systems, methods, and devices are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described systems, methods, and devices. When combinations, subsets, interactions, groups, etc., of these components are described, it is understood that while specific references to each of the various individual and collective combinations and permutations of these may not be explicitly described, each is specifically contemplated and described herein, for all systems, methods, and devices. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the systems, methods, and devices may take the form of an entirely hardware embodiment, an entirely software embodiment, or an embodiment combining software and hardware aspects. Furthermore, the systems, methods, and devices may take the form of a computer program product on a computer-readable storage medium having computer-readable program instructions (e.g., computer software) embodied in the storage medium. More particularly, the present systems, methods, and devices may take the form of web-implemented computer software. Any suitable computer-readable storage medium may be utilized including hard disks, CD-ROMs, optical storage devices, or magnetic storage devices.

Embodiments of the systems, methods, and devices are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the systems, methods, and devices have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

1. A method comprising:
receiving a plurality of requests associated with storing a digital video asset;
assigning a first subset of the plurality of requests to a first batch of a plurality of batches;
determining that a quantity of requests associated with the first batch satisfies a threshold;
sending, based on the quantity of requests associated with the first batch satisfying the threshold, the first batch to a first recording service;
assigning a second subset of the plurality of requests to a second batch of the plurality of batches;
determining that a quantity of requests associated with the second batch satisfies the threshold; and
sending, based on the quantity of requests associated with the second batch satisfying the threshold, the second batch to a second recording service.

2. The method of claim 1, wherein the threshold comprises a predetermined quantity of requests for a batch, and wherein a batch of the plurality of batches satisfies the threshold if the batch comprises a quantity of requests within a range of the predetermined quantity of requests.

3. The method of claim 1, further comprising:
generating, at the first recording service, an indication of segment data for the requests in the first batch; and
generating, at the second recording service, an indication of segment data for the requests in the second batch.

4. The method of claim 3, wherein at least one of the indication of segment data for the requests in the first batch or the indication of segment data for the requests in the second batch comprises at least one of a start time, an end time, a duration, or an identification number.

5. The method of claim 1, further comprising:
sending, by the first recording service to a first segment recorder, an indication of segment data for the requests in the first batch;
sending, by the second recording service to a second segment recorder, an indication of segment data for the requests in the second batch;
generating, based on the indication of segment data for the requests in the first batch, and at the first segment recorder, a recording associated with each request in the first batch; and
generating, based on the indication of segment data for the requests in the second batch, and at the second segment recorder, a recording associated with each request in the second batch.

6. The method of claim 1, further comprising:
determining, based on an indication of segment data for the requests in the first batch, that at least one request in the first batch is complete; and
removing, based on the determining that the at least one request is complete, the at least one request from the first batch.

7. The method of claim 1, wherein the first recording service is different than the second recording service.

8. A method comprising:
receiving a plurality of requests associated with storing a digital video asset;
assigning a first subset of the plurality of requests to a first batch of a plurality of batches;
determining that a quantity of requests associated with the first batch satisfies a threshold;
sending, based on the quantity of requests associated with the first batch satisfying the threshold, the first batch to a first recording service;
assigning a second subset of the plurality of requests to a second batch of the plurality of batches;
determining that a quantity of requests associated with the second batch does not satisfy the threshold; and
adding, based on the quantity of requests associated with the second batch not satisfying the threshold, an additional request to the second batch.

9. The method of claim 8, further comprising:
sending, by the first recording service to a first segment recorder, an indication of segment data for the requests in the first batch; and
generating, based on the indication of segment data, and at the first segment recorder, a recording associated with each request in the first batch.

10. The method of claim 9, wherein generating the recording associated with each request in the first batch comprises:
receiving, at the first segment recorder, at least one segment associated with the indication of segment data.

11. The method of claim 8, further comprising:
determining, based on adding the additional request to the second batch, that the quantity of requests associated with the second batch satisfies the threshold; and
sending, based on the quantity of requests associated with the second batch satisfying the threshold, the second batch to a second recording service.

12. The method of claim 11, wherein the second recording service is different than the first recording service.

13. The method of claim 8, wherein adding, based on the quantity of requests associated with the second batch not satisfying the threshold, the additional request to the second batch comprises:
adding, to the second batch, an additional request associated with storing the digital video asset.

14. A method comprising:
receiving a plurality of requests associated with storing a digital video asset;
assigning a first subset of the plurality of requests to a first batch of a plurality of batches;
determining that a quantity of requests associated with the first batch satisfies a threshold;
sending, based on the quantity of requests associated with the first batch satisfying the threshold, the first batch to a first recording service;
assigning a second subset of the plurality of requests to a second batch of the plurality of batches;
determining a load associated with the first recording service; and
sending, based on the load, the second batch to a second recording service.

15. The method of claim 14, wherein determining the load associated with the first recording service comprises:
determining that the first recording service is overloaded with batches.

16. The method of claim 14, wherein the second recording service is different than the first recording service.

17. The method of claim 14, wherein the threshold comprises a predetermined quantity of requests for a batch, and wherein a batch of the plurality of batches satisfies the threshold if the batch comprises a quantity of requests within a range of the predetermined quantity of requests.

18. The method of claim 14, further comprising:
sending, by the first recording service to a first segment recorder, an indication of segment data for the requests in the first batch;
sending, by the second recording service to a second segment recorder, an indication of segment data for the requests in the second batch;
generating, based on the indication of segment data for the requests in the first batch, and at the first segment recorder, a recording associated with each request in the first batch; and
generating, based on the indication of segment data for the requests in the second batch, and at the second segment recorder, a recording associated with each request in the second batch.

19. The method of claim 18, wherein at least one of the indication of segment data for the requests in the first batch or the indication of segment data for the requests in the second batch comprises at least one of a start time, an end time, a duration, or an identification number.

20. The method of claim 18, wherein generating the recording associated with each request in the first batch comprises:
receiving, at the first segment recorder, at least one segment associated with the indication of segment data for the requests in the first batch, and wherein generating the recording associated with each request in the second batch comprises:
receiving, at the second segment recorder, at least one segment associated with the indication of segment data for the requests in the second batch.
